(19) United States
(12) Patent Application Publication
(10) Pub. No.: US 2017/0108951 A1
(43) Pub. Date: Apr. 20, 2017

(54) Open Sided Ergonomic Grip

(71) Applicant: Microsoft Technology Licensing, LLC, Redmond, WA (US)

(72) Inventor: Bradley E. Clements, Fort Collins, CO (US)

(21) Appl. No.: 14/918,292

(22) Filed: Oct. 20, 2015

(51) Int. Cl. G06F 3/0354; G06F 3/039; B25G 1/10

(52) U.S. Cl. CPC G06F 3/03545; B25G 1/102; G06F 3/039

(57) ABSTRACT

An open sided ergonomic grip is described. In at least some embodiments, the described grip is configured for a handheld apparatus and consists of at least two parts, a rigid body portion and an inner elastic portion. The body portion has a longitudinal opening that allows functionality of a handheld apparatus to be accessible. According to one or more embodiments, the inner elastic portion has a protrusion which concentrates pressure from a user's grasp against a handheld input apparatus to hold the grip in place

### BACKGROUND

Mobile computing devices have been developed to increase the functionality that is made available to users in a modern setting. For example, a user may interact with a mobile phone, tablet computer, or other mobile computing device to check email, surf the web, compose texts, interact with applications, and so on. Many users use a stylus to interact with a touch screen in order to provide a more controlled and intuitive input method for writing, drawing, drafting, and so on. Because of the extended time period of use by many of these users, an ergonomic grip may be used to allow users to avoid hand pain. However, typical ergonomic grips do not account for functionality (e.g., magnets, buttons, controls, and so forth) on a surface of a stylus and thus may impede such functionality.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An open sided ergonomic grip is described. In at least some embodiments, the described grip is configured for a handheld apparatus and consists of at least two parts, a rigid body portion and an inner elastic portion. The body portion has a longitudinal opening that allows functionality of a handheld apparatus to be accessible. According to one or more embodiments, the inner elastic portion has a protrusion which concentrates pressure from a user's grasp against a handheld input apparatus to hold the grip in place.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques discussed herein in accordance with one or more embodiments.

FIG. 2 illustrates an example of an ergonomic grip in accordance with one or more embodiments.

FIG. 3 illustrates an example orientation of an ergonomic grip in accordance with one or more embodiments.

FIG. 4 illustrates an example orientation of an ergonomic grip in accordance with one or more embodiments.

FIG. 5 illustrates an example orientation of an ergonomic grip in accordance with one or more embodiments.

FIG. 6 illustrates an example orientation of an ergonomic grip in accordance with one or more embodiments.

FIG. 7 illustrates an example orientation of an ergonomic grip in accordance with one or more embodiments.

FIG. 8 illustrates an example orientation of an ergonomic grip and stylus in accordance with one or more embodiments.

FIG. 9 illustrates an example orientation of an ergonomic grip and stylus in accordance with one or more embodiments.

FIG. 10 illustrates an example system and computing device as described with reference to FIG. 1, which are configured to implement embodiments of techniques described herein.

### DETAILED DESCRIPTION

Overview

An open sided ergonomic grip is described. Generally, the grip is configured for a handheld input apparatus, such as a stylus. In at least some implementations, the described grip has an open side, the edges of which are flush with a peripheral surface of a stylus when the grip is attached to the stylus. The open side leaves a portion of the peripheral surface of the stylus exposed, thus enabling a functionality on the peripheral surface of the stylus to be accessible. For instance, the open side allows a magnetic strip of the stylus to be exposed such that the stylus can be magnetically attached to an apparatus, such as a mobile computing device.

According to various implementations, an ergonomic grip has a rigid portion that forms a body of the grip. The ergonomic grip further has an elastic portion positioned within the rigid body. Generally, the elastic portion expands against a stylus when a user grasps the ergonomic grip, such as to keep the grip locked in place on the stylus. While implementations are discussed herein with reference to an ergonomic grip for a stylus, it is to be appreciated that implementations for an open sided ergonomic grip described herein can be utilized to provide a grip for a variety of different handheld apparatus.

According to various implementations, the open side of the ergonomic grip allows functionality on a stylus to remain accessible. The described ergonomic grip also offers ergonomic benefits for users who utilize a stylus for long periods of time. For instance, by creating an enhanced area for a user to hold, hand pain associated with using a stylus can be reduced or avoided. Further, the ergonomic grip includes grip pad that physically interfaces with a stylus to lock the grip in place on the stylus.

In the following discussion, an example environment is first described that may employ the techniques described herein. Embodiments discussed herein are not limited to the example environment, and the example environment is not limited to embodiments discussed herein. Next, a section entitled “Example Grip” describes example attributes of an example grip in accordance with one or more implementations. Following this, a section entitled “Grip in Use” describes an example grip and stylus in accordance with one or more implementations. Finally, a section entitled “Example System and Device” describes an example device and system with which the grip can be used in accordance with one or more implementations.

Example Environment

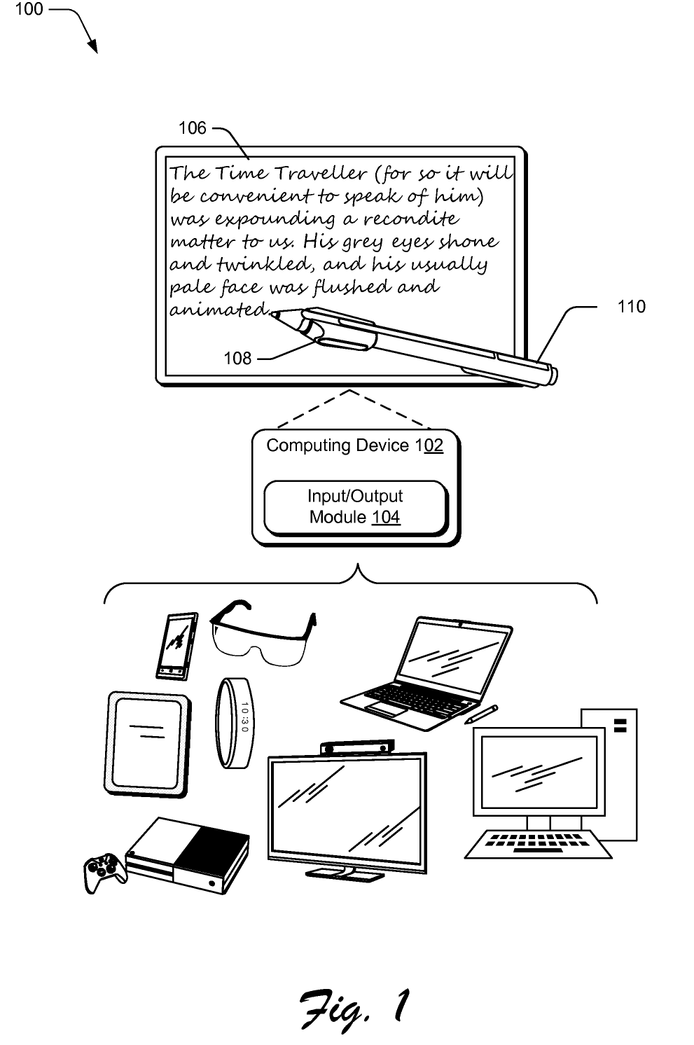

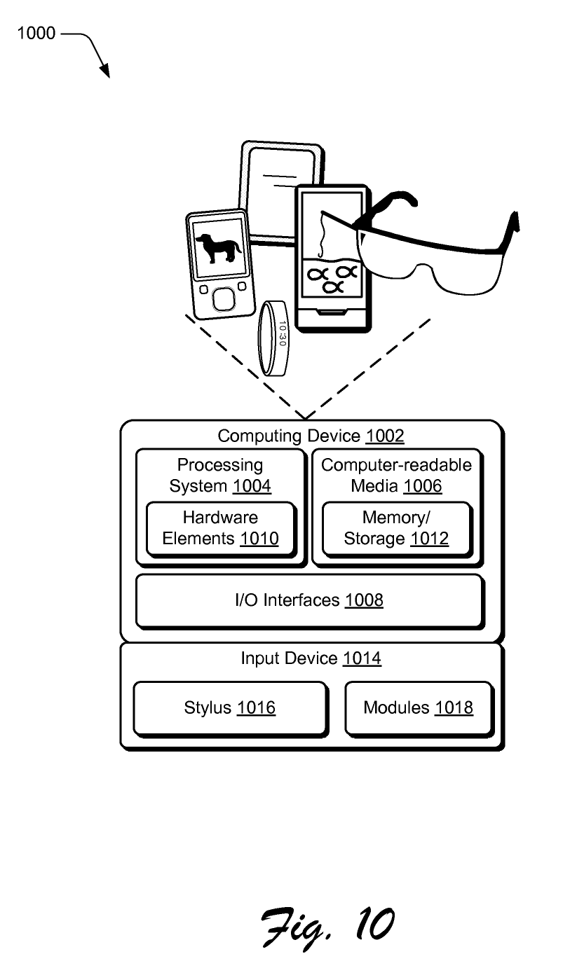

FIG. 1 is an illustration of an environment 100 in an example implementation that is operable to employ the techniques described herein. The illustrated environment 100 includes an example of a computing device 102. Generally, the computing device 102 may range from full resource devices with substantial memory and processor resources, to a low-resource device with limited memory and/or processing resources. An example implementation of the computing device 102 is discussed below with reference to FIG. 10.

The computing device 102 includes a variety of different functionalities that enable various activities and tasks to be performed. For instance, the computing device 102 includes an Input/Output Module 104, which is representative of functionality relating to processing of inputs and rendering outputs of the computing device 102. A variety of different inputs may be processed by the input/output module 104, such as inputs relating to touch inputs involving a stylus on a display device 106, functions that correspond to keys or buttons of an input device, keys of a virtual keyboard displayed by the display device 106, and so forth. Thus, the input/output module 104 may support a variety of different input techniques by recognizing and leveraging a division between types of inputs including key presses, touch gestures, touchless gestures recognized via a camera functionality of the computing device 102, and so on.

The environment 100 also includes attached grip 108 attached to a stylus 110. In at least some implementations, the grip 108 is removable from the stylus 110 such that the grip 108 can be attached to another handheld instrument where a user could benefit from an ergonomic grip, such as a pen, a marker, a pointer, and so forth. While the implementations presented herein are discussed in the context of a stylus, it is to be appreciated that various other types of handheld apparatus may also be used with the described ergonomic grip.

Example Grip

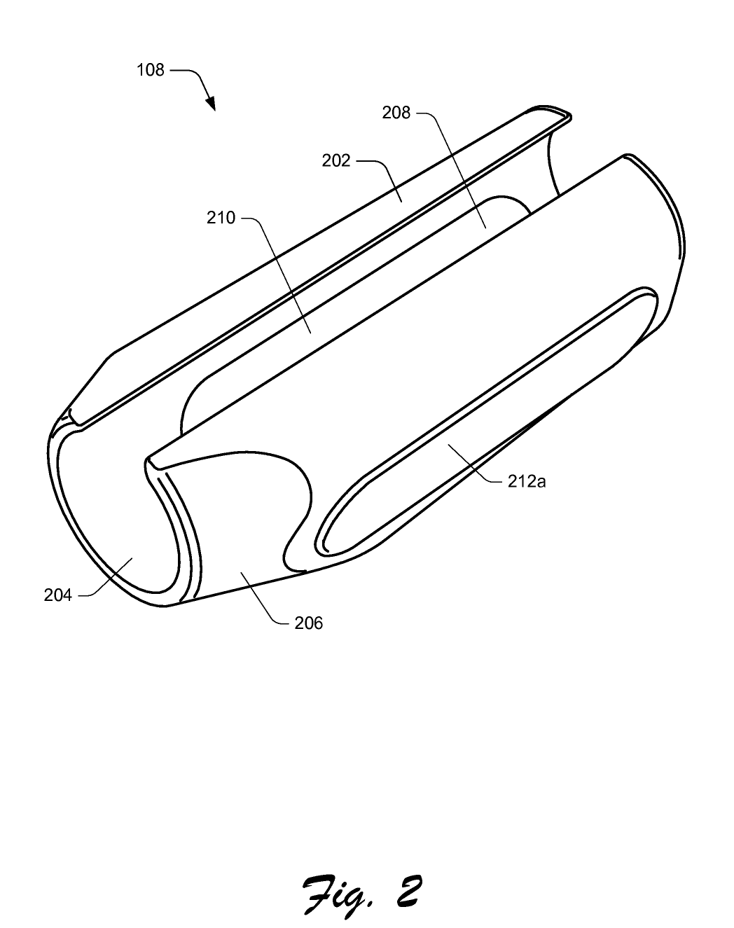

FIG. 2 shows the grip 108 in accordance with one or more implementations. The grip 108 includes a grip body 202 having an inner surface 204 and an outer surface 206. According to various implementations, the grip body 202 may be made from hard plastic or other suitable rigid material. The grip 108 further includes a grip pad 208 disposed within the grip body 202 and having an inner surface 210 and an outer surface 212a. In at least some implementations, the grip body 202 is formed from a higher durometer material (i.e., a harder, more rigid material) than the grip pad 208.

Generally, the grip 108 can be made in any suitable way. For instance, the grip 108 may be formed using a two part injection molding process in which the grip body 202 is molded from a rigid material first, followed by an elastic material (e.g. an elastomer) injected into a cavity of the grip body 202 to form the grip pad 208. In at least some implementations, the inner surface 210 and outer surface 212a of the grip pad 208 may be part of a single piece of elastic material disposed within the grip body 202.

According to various implementations, the outer surface 212a of the grip pad 208 protrudes from the outer surface 206 of the grip body 202. Thus, a user may hold the grip 108 with their fingers resting along the outer surface 212a of the grip pad 208. This way, the grip pad 208 offers a comfortable holding surface for a user while at the same time acting to lock the grip in place on a stylus through pressure applied by a user in holding the grip 108, as detailed below.

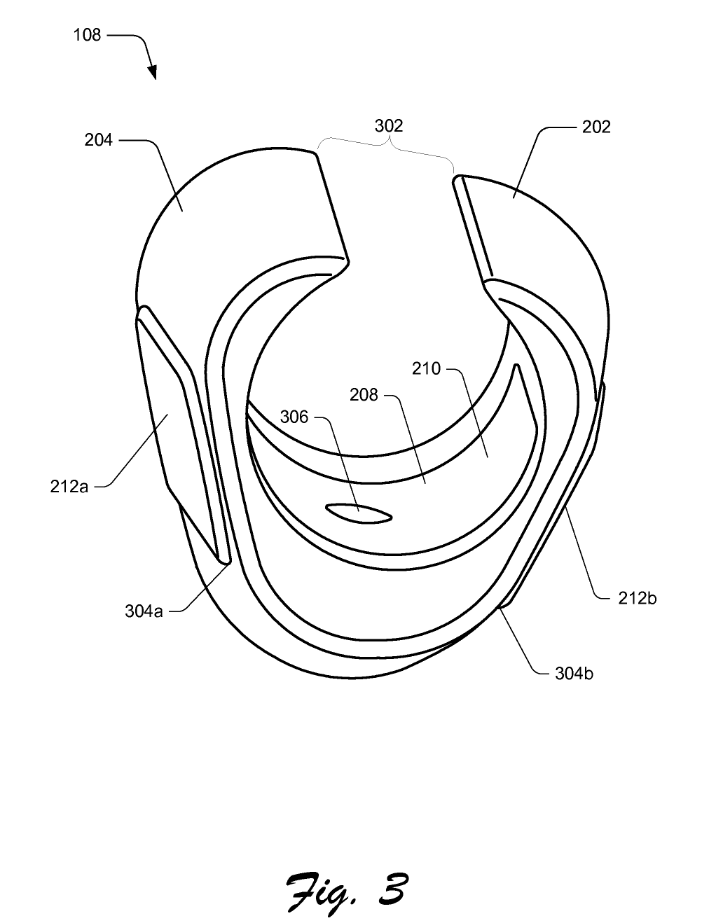

FIG. 3 shows a rear facing view of the grip 108 in accordance with one or more implementations. As shown in this view, the grip body 202 is generally triangular in geometry with two sides for a user to hold and an opening 302 on a third side. According to various implementations, the triangular shape of the grip body 202 helps to keep a stylus oriented in a user's hand. Further, the outer surface 212a and an outer surface 212b of the grip pad 208 protrudes through to the outer surface 206 of the grip body 202 through an aperture 304a and an aperture 304b in the grip body 202. In this particular implementation the apertures 304a, 304b are located on the two sides of the triangular grip body 202. Although the apertures 304a, 304b are illustrated as being rectangular, this is not intended to be limiting, and the apertures 304a, 304b may be implemented according to any suitable shape and/or geometry. As further depicted, the grip pad 208 fills the apertures 304a, 304b and is raised slightly above the outer surface 206 grip body 202.

According to various implementations, the grip pad 208 is partially contained within the grip body 202 such that the grip body 202 limits the directions in which the grip pad 208 can expand. For instance, when a user presses on the outer surfaces 212a, 212b of the grip pad 208 when holding the grip 108, the grip pad 208 expands such that compression force from the grip pad 208 is concentrated into and against a handheld apparatus around which the grip 108 may be situated.

The inner surface 210 of the grip pad 208 includes a protrusion 306 located across from the opening 302. According to one or more implementations, the protrusion 306 represents a portion of the grip pad 208 that protrudes above the surface of the inner surface 210 and extends toward a central longitudinal axis of the grip 108. Generally, the protrusion 306 is disposed so that when the grip 108 is attached to a stylus, the protrusion 306 makes contact with the stylus. Further, the protrusion 306 pushes against the stylus responsive to a user applying pressure to the outer surfaces 212a, 212b of the grip pad. For instance, the grip body 202 directs compression of the grip pad 208 inward towards a central longitudinal axis of the grip 108 and against an outer surface of the stylus, and limits expansion of the grip pad 208 in other directions. This causes a resulting expansion force to be concentrated through the protrusion 306 which swells against the stylus to enhance axial locking friction between the grip pad 208 and the stylus, and thus limits movement of the grip 108 relative to the stylus. In at least some implementations, inward expansion of the grip pad 208 can be modeled using a Poisson ratio which relates the volumetric displacement of the grip pad 208 toward a stylus caused by the user's hold on the outside of the grip pad 208 to the surface area of the user's hold and the surface area of the inside of the grip pad 208.

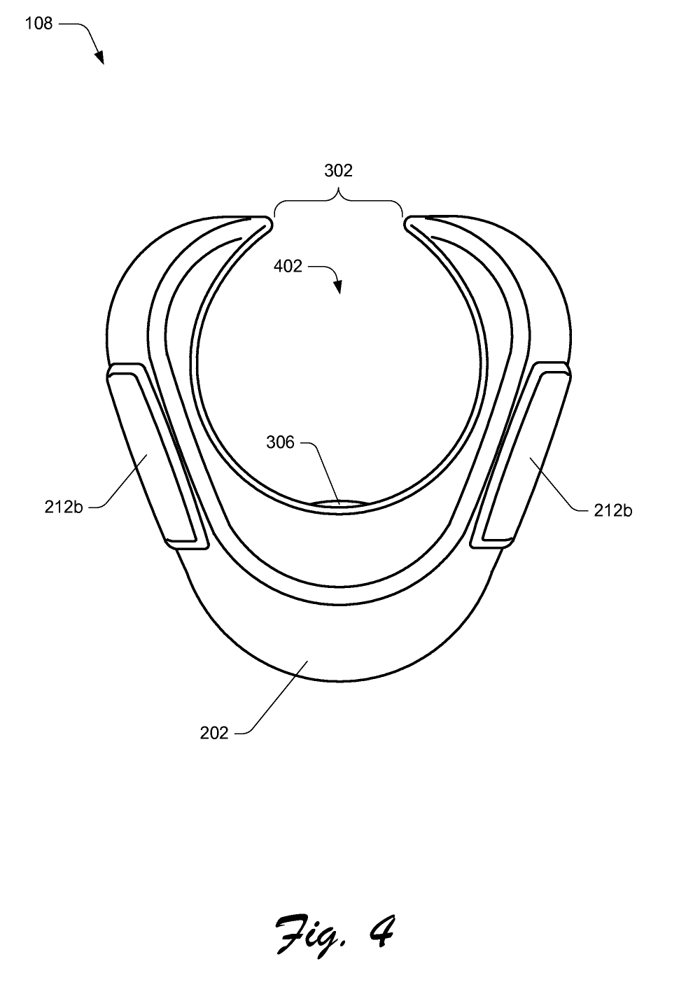

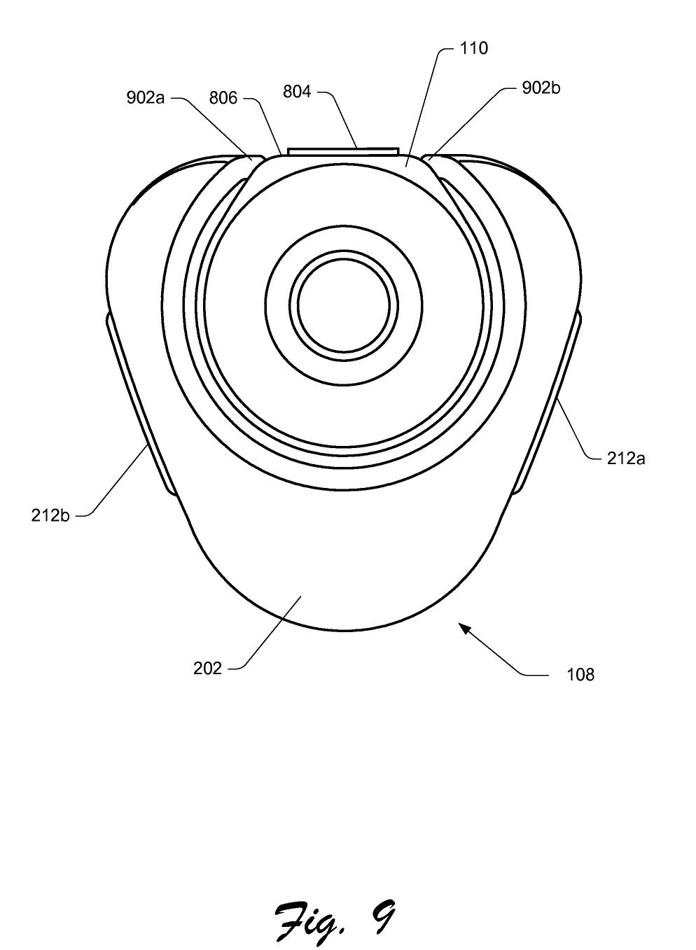

FIG. 4 depicts a rear facing view of the grip 108 in accordance with one or more implementations. As illustrated in this view, the grip body 202 has an arc-shaped lateral cross section. The opening 302 in the grip body 202 is disposed directly across a central cavity 402 of the grip 108 from the protrusion 306. Further, the protrusion 306 extends into the central cavity 402. As further detailed below in the discussion of FIG. 9, when the grip 108 is placed on a stylus, the stylus fills the central cavity 402 of the grip body 202 and the protrusion 306 applies elastic pressure against the stylus.

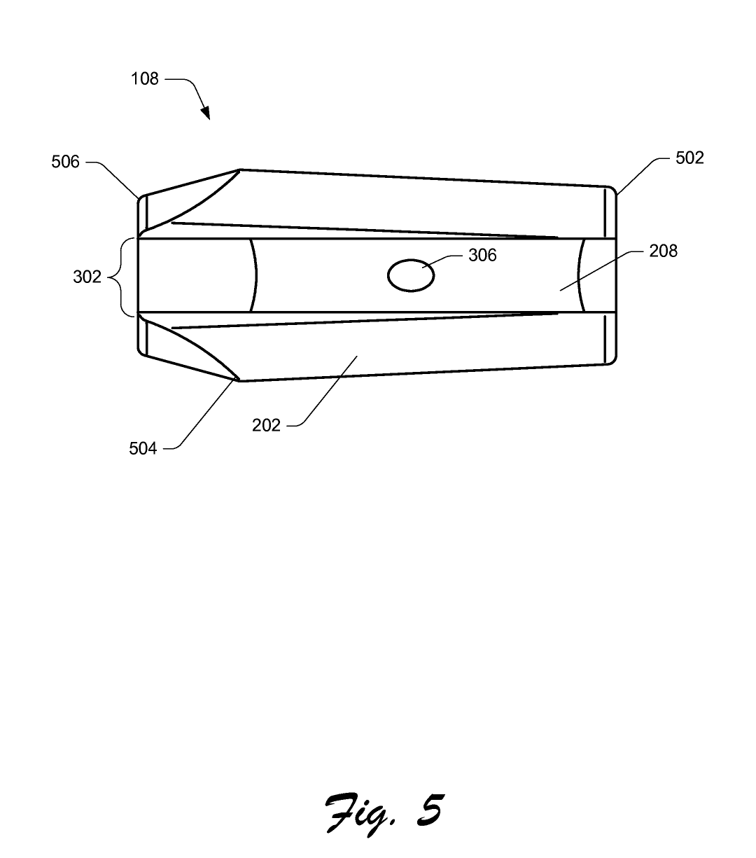

FIG. 5 depicts an overhead view of the grip 108 in accordance with one or more implementations. This view shows the opening 302 in the grip body 202 through which the protrusion 306 of the grip pad 208 is visible. FIG. 5 further shows the longitudinally tapered geometry of the grip body 202. For instance, the circumference of the grip body 202 increases from a rear portion 502 to a maximum circumference at a forward point 504 near a front edge 506 of the grip body 202. This taper creates a backwards force bias so that when a user pushes down, their hand pushes against the forward point 504 on the grip body 202 creating a backwards reactionary force that compresses the rear portion 502 to keep the grip 108 locked in place on a stylus instead of sliding down a shaft.

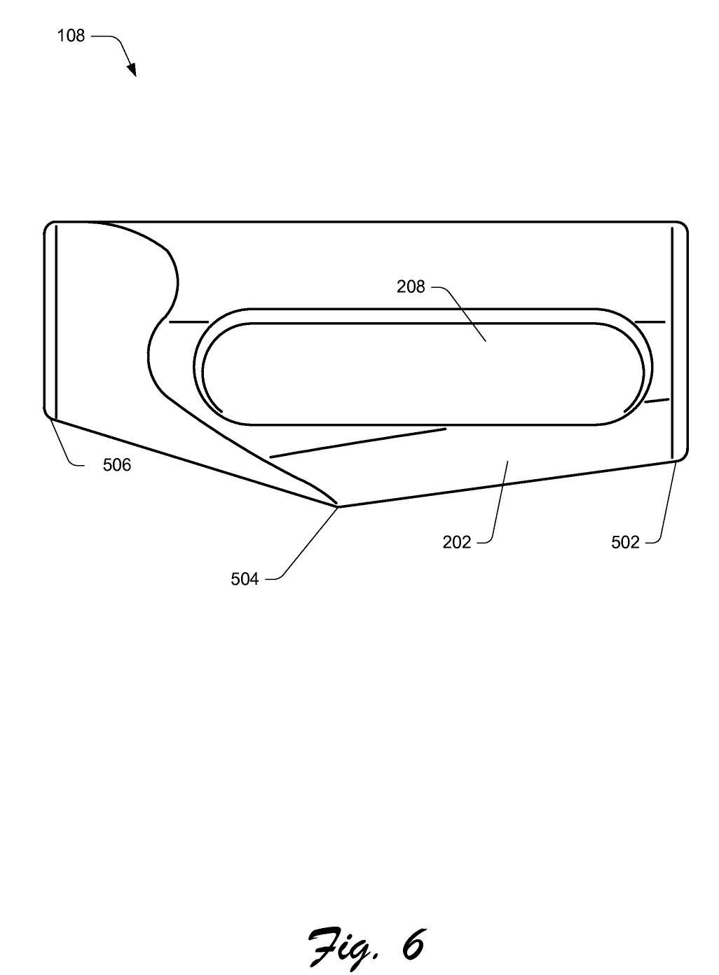

FIG. 6 depicts a side view of the grip 108 in accordance with one or more implementations. This view further illustrates the taper of grip 108 from the forward point 504 to the rear portion 502. In holding the grip 108, the user's fingers may be placed on the grip pad 208 so that the user's fingertips align with the forward point 504 on the grip body 202. When the user squeezes the grip 108, the geometry of the grip 108 is such that expansion force of the grip pad 208 is focused on the protrusion 306 depicted in other drawings. This expansion of the protrusion 306 against a stylus creates axial locking friction that mitigates movement of the grip relative to the stylus.

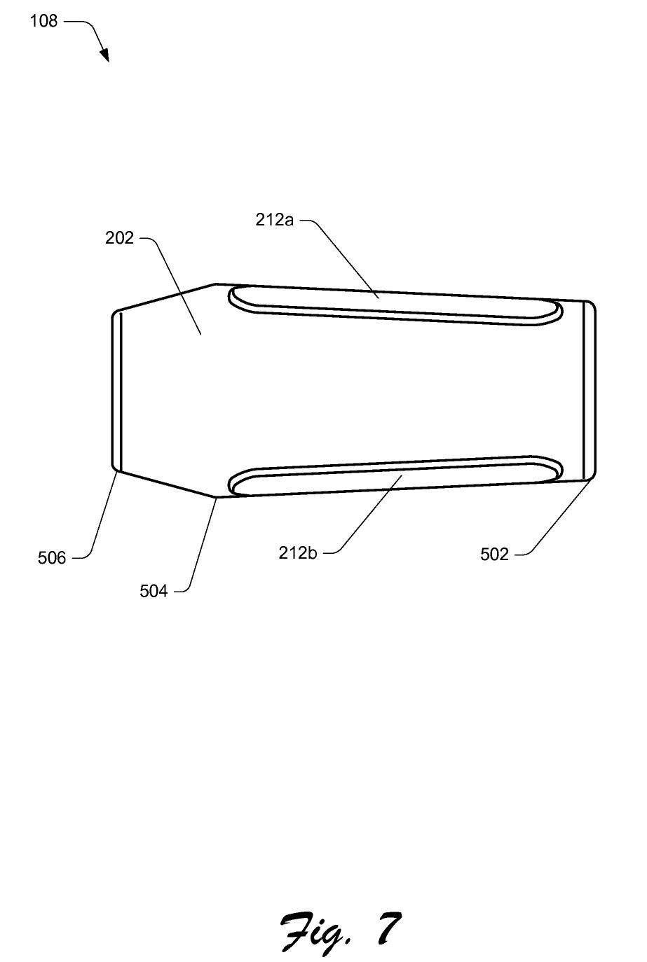

FIG. 7 depicts a bottom view of a grip 108 in accordance with one or more implementations. This view illustrates the taper of grip body 202 from the forward point 504 to the rear portion 502. Further shown are the outer surfaces 212a, 212b of the grip pad 208.

Grip in Use

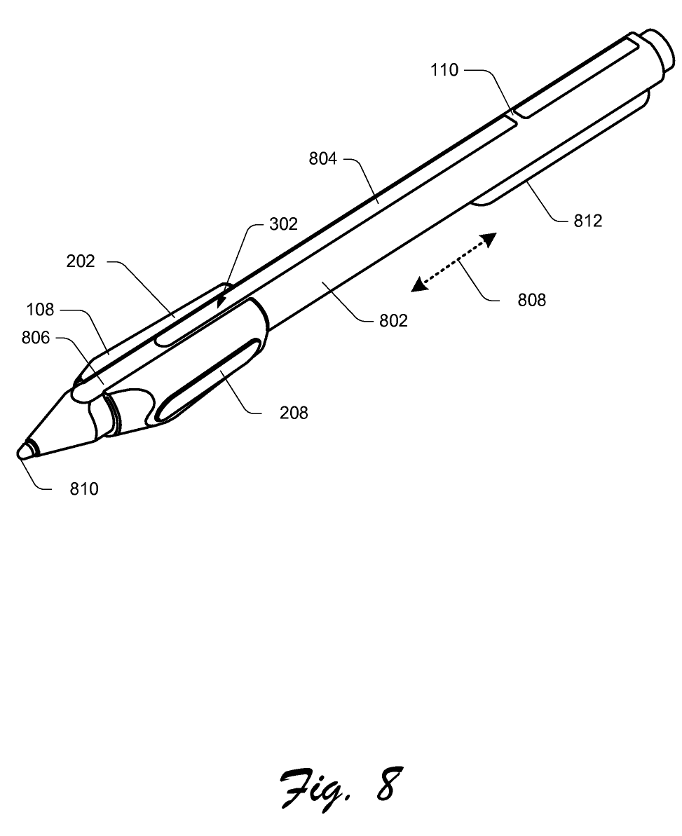

FIG. 8 depicts the grip 108 attached to the stylus 110 in accordance with one or more implementations. The stylus 110 includes a shaft 802 with a magnetic strip 804 that extends along a flat side 806 of the shaft 802 and along a longitudinal axis 808 of the shaft 802. According to various implementations, the magnetic strip 804 allows the user to attach the stylus 110 to a metallic portion of an apparatus, such as a bezel of the computing device 102. Further, the magnetic strip 804 may be oriented along the flat side 806 to enable a user to orient the stylus 110 in their hand and prevent the stylus from rotating during use.

The stylus 110 further includes a tip 810 on one end for contacting an input surface, such as for applying digital ink to the display device 106. The stylus 110 also includes a clip 812 along the edge of the shaft 802 to allow the user to clip the stylus to an object or to keep the stylus from sliding through a holding loop. According to one or more implementations, additional functionality not specifically depicted here may be added to the shaft 802 (e.g., along the flat side 806) and/or other portion of the stylus 110 such the functionality is accessible by being exposed through the longitudinal opening 302 in the grip body 202. Thus, the opening 302 allows the grip 108 to be used to increase user comfort without reducing access to functionality disposed on the shaft 802 of the stylus 110.

As previously discussed, the grip 108 has a longitudinally tapered geometry. For instance, the widest point of the grip 108 is located close to the tip 810 with a decreasing circumference toward a rear of the stylus 110. This taper creates a rearward bias so that when a user squeezes the grip 108, their hand pushes against the wide part of the grip 108 and creates a backwards reactionary force that compresses the rearward portion of the grip 108 to keep the grip 108 locked in place on the stylus 110 instead of sliding along the shaft 802. The protrusion 306, shown in other drawings, concentrates the force applied to the grip 108 against the stylus 110 further locking the grip 108 in place on the stylus 110.

According to one or more implementations the grip 108 is moveable longitudinally to any suitable position along the shaft 802, such as when a user is not compressing the grip 108. Such movement is useful to accommodate different usage scenarios and different user preferences. Generally, the grip 108 may be configured to slide under the clip 812, slide over the clip 812 and/or be stopped in sliding by the clip 812 such as for storage of the stylus 110.

FIG. 9 depicts a front facing view of the grip 108 attached to the stylus 110. This particular view emphasizes that the grip body 202 is molded into an ergonomically comfortable shape. As previously discussed, the grip body 202, in conjunction with the flat side 906 of the stylus, creates a rounded triangle-like shape for a user to hold. The triangular shape of the grip body 202 helps to keep the stylus 110 oriented in the user's hand. This ease in orientation allows a user to easily keep the stylus 110 from rotating during use in order to maintain access to functionality on the shaft 802.

The flat side 806 of the stylus 110 lies flush with a grip edge 902a and a grip edge 902b surrounding the opening 302. This is not intended to be limiting, however, and the flat side 806 may protrude through the grip edges 902a, 902b, or may be recessed lower than the grip edges 902a, 902b. In this particular implementation, the flat side 806 is even with the grip edge 902a, 902b which allows functionality along the flat side 806 to be exposed. For instance, the magnetic strip 804 along the flat edge 806 is exposed to enable the stylus 110 to be magnetically or otherwise attached to a computing device or other surface. In an implementation where the flat side 806 includes a button or other functionality, exposing the flat side 806 allows a user to easily access the functionality without interference from the grip 108.

Thus the described ergonomic grip provides a way of increasing user comfort while utilizing a handheld apparatus such as a stylus, while avoiding interference with functionality that is exposed at a surface of the handheld apparatus.

Example System and Device

FIG. 10 illustrates an example system generally at 1000 that includes an example computing device 1002 that is representative of one or more computing systems and/or devices that may implement the various techniques described herein. In at least some implementations, the computing device 1002 represents an implementation of the computing device 102 discussed above. The computing device 1002 may be, for example, be configured to assume a mobile configuration through use of a housing formed and sized to be grasped and carried by one or more hands of a user, illustrated examples of which include a mobile phone, mobile game and music device, and tablet computer although other examples are also contemplated. In at least some implementations, the computing device 102 may be implemented as a wearable device, such as a smart watch, smart glasses, and so forth.

The example computing device 1002 as illustrated includes a processing system 1004, one or more computer-readable media 1006, and one or more I/O interface 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1006 is illustrated as including memory/storage 1012. The memory/storage 1012 represents memory/storage capacity associated with one or more computer-readable media. The memory/storage component 1012 may include volatile media (such as random access memory (RAM)) and/or nonvolatile media (such as read only memory (ROM), Flash memory, optical disks, magnetic disks, and so forth). The memory/storage component 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 may be configured in a variety of ways to support user interaction.

The computing device 1002 is further illustrated as being communicatively and physically coupled to an input device 1014 that is physically and communicatively removable from the computing device 1002. In this way, a variety of different input devices may be coupled to the computing device 1002 having a wide variety of configurations to support a wide variety of functionality. In this example, the input device 1014 includes one or more keys 1016, which may be configured as pressure sensitive keys, mechanically switched keys, and so forth.

The input device 1014 is further illustrated as include one or more modules 1018 that may be configured to support a variety of functionality. The one or more modules 1018, for instance, may be configured to process analog and/or digital signals received from the keys 1016 to determine whether a keystroke was intended, determine whether an input is indicative of resting pressure, support authentication of the input device 1014 for operation with the computing device 1002, and so on.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of a module that is executable by the computing device 1002 as software may be achieved at least partially in hardware, e.g., through use of computer-readable storage media and/or hardware elements 1010 of the processing system 1004. The instructions and/or functions may be executable/operable by one or more articles of manufacture (for example, one or more computing devices 1002 and/or processing systems 1004) to implement techniques, modules, and examples described herein.

Implementations discussed herein include:

### Example 1

A grip for a handheld apparatus, the grip including: a grip body formed from a first material and having an interior surface with an arc-shaped lateral cross section; and an elastic portion inset into the interior surface of the grip body, the elastic portion being formed from a second material that is softer than the first material and having a protrusion from a surface of the elastic portion such that compression of the elastic portion causes the protrusion to swell inward within the interior surface of the grip body.

### Example 2

A grip as described in example 1, further including a longitudinal opening in the grip body disposed across the arc-shaped lateral cross section from the protrusion.

### Example 3

A grip as described in one or more of examples 1 or 2, wherein the first material includes a hard plastic and the second material includes an elastomer.

### Example 4

A grip as described in one or more of examples 1-3, wherein the grip body concentrates pressure exerted on an outer side of the grip body inwardly onto the protrusion by limiting a direction of expansion for the elastic portion.

### Example 5

A grip as described in one or more of examples 1-4, wherein the protrusion expands relative to a Poisson ratio in response to compression of the grip body.

### Example 6

A grip as described in one or more of examples 1-5, wherein the grip body has a forward point and a rear portion opposite the forward point, the grip body being tapered from the forward point to the rear portion such that the forward point has a larger circumference than the rear portion.

### Example 7

A stylus including: a shaft; and a grip positioned partially around the shaft and being moveable along the shaft, the grip having a longitudinal opening formed such that a longitudinal portion of the shaft lies flush with an edge of the grip along the longitudinal opening.

### Example 8

A stylus as described in example 7, wherein the shaft includes a magnetic strip disposed longitudinally along the shaft and that is exposed by the longitudinal opening.

### Example 9

A stylus as described in one or more of examples 7 or 8, wherein the grip includes a rigid body portion and a flexible elastic portion disposed at least partially within the body portion.

### Example 10

A stylus as described in one or more of examples 7-9, wherein the grip includes a rigid body portion and a flexible elastic portion disposed at least partially within the body portion, and wherein the elastic portion is at least partially exposed through one or more apertures in the body portion.

### Example 11

A stylus as described in one or more of examples 7-10, wherein the grip includes a rigid body portion and a flexible elastic portion disposed at least partially within the body portion, and wherein the elastic portion has a protrusion disposed between an inner surface of the grip and the shaft that expands inward against the shaft when pressure is applied to the grip.

### Example 12

A stylus as described in one or more of examples 7-11, wherein the grip is removable from the shaft.

### Example 13

A stylus as described in one or more of examples 7-12, wherein the grip has a forward point and a rear portion opposite the forward point, the grip being tapered from the forward point to the rear portion.

### Example 14

An open sided grip for a handheld apparatus, the grip including: a grip body having a forward point and a rear portion opposite the forward point, the grip body being tapered from the forward point to the rear portion and having at least one aperture along the taper between the forward point and rear portion; and an elastic portion positioned within the aperture and having an outer surface and an interior surface, the outer surface and the interior surface being at least partially exposed through the at least one aperture and the interior surface having a protrusion such that compression of the elastic portion causes the protrusion to expand inward into a central cavity of the grip body.

### Example 15

An open sided grip as described in example 14, further including a longitudinal opening in the grip body that extends from a front edge to a rear portion of the grip body.

### Example 16

An open sided grip as described in one or more of examples 14 or 15, further including a longitudinal opening in the grip body formed such that when the open sided grip is attached to a handheld apparatus, a longitudinal portion of the handheld apparatus lies flush with an edge of the grip along the longitudinal opening.

### Example 17

An open sided grip as described in one or more of examples 14-16, further including a longitudinal opening positioned across the central cavity of the grip body from the protrusion.

### Example 18

An open sided grip as described in one or more of examples 14-17, wherein the grip body includes a hard plastic material, and the elastic portion includes an elastomer.

### Example 19

An open sided grip as described in one or more of examples 14-18, wherein pressure exerted on the grip body causes compression of the elastic portion.

### Example 20

An open sided grip as described in one or more of examples 14-19, wherein the outer surface of the elastic portion is raised in relation to an external surface of the grip body.

What is claimed is:

1. A grip for a handheld apparatus, the grip comprising:
a grip body formed from a first material and having an interior surface with an arc-shaped lateral cross section; and
an elastic portion inset into the interior surface of the grip body, the elastic portion being formed from a second material that is softer than the first material and having a protrusion from a surface of the elastic portion such that compression of the elastic portion causes the protrusion to swell inward within the interior surface of the grip body.

2. A grip as recited in claim 1, further comprising a longitudinal opening in the grip body disposed across the arc-shaped lateral cross section from the protrusion.

3. A grip as recited in claim 1, wherein the first material comprises a hard plastic and the second material comprises an elastomer.

4. A grip as recited in claim 1, wherein the grip body concentrates pressure exerted on an outer side of the grip body inwardly onto the protrusion by limiting a direction of expansion for the elastic portion.

5. A grip as recited in claim 1, wherein the protrusion expands relative to a Poisson ratio in response to compression of the grip body.

6. A grip as recited in claim 1, wherein the grip body has a forward point and a rear portion opposite the forward point, the grip body being tapered from the forward point to the rear portion such that the forward point has a larger circumference than the rear portion.

7. A stylus comprising:
a shaft; and
a grip positioned partially around the shaft and being moveable along the shaft, the grip having a longitudinal opening formed such that a longitudinal portion of the shaft lies flush with an edge of the grip along the longitudinal opening.

8. A stylus as recited in claim 7, wherein the shaft includes a magnetic strip disposed longitudinally along the shaft and that is exposed by the longitudinal opening.

9. A stylus as recited in claim 7, wherein the grip comprises a rigid body portion and a flexible elastic portion disposed at least partially within the body portion.

10. A stylus as recited in claim 7, wherein the grip comprises a rigid body portion and a flexible elastic portion disposed at least partially within the body portion, and wherein the elastic portion is at least partially exposed through one or more apertures in the body portion.

11. A stylus as recited in claim 7, wherein the grip comprises a rigid body portion and a flexible elastic portion disposed at least partially within the body portion, and wherein the elastic portion has a protrusion disposed between an inner surface of the grip and the shaft that expands inward against the shaft when pressure is applied to the grip.

12. A stylus as recited in claim 7, wherein the grip is removable from the shaft.

13. A stylus as recited in claim 7, wherein the grip has a forward point and a rear portion opposite the forward point, the grip being tapered from the forward point to the rear portion.

14. An open sided grip for a handheld apparatus, the grip comprising:
a grip body having a forward point and a rear portion opposite the forward point, the grip body being tapered from the forward point to the rear portion and having at least one aperture along the taper between the forward point and rear portion; and
an elastic portion positioned within the aperture and having an outer surface and an interior surface, the outer surface and the interior surface being at least partially exposed through the at least one aperture and the interior surface having a protrusion such that compression of the elastic portion causes the protrusion to expand inward into a central cavity of the grip body.

15. An open sided grip as recited in claim 14, further comprising a longitudinal opening in the grip body that extends from a front edge to a rear portion of the grip body.

16. An open sided grip as recited in claim 14, further comprising a longitudinal opening in the grip body formed such that when the open sided grip is attached to a handheld apparatus, a longitudinal portion of the handheld apparatus lies flush with an edge of the grip along the longitudinal opening.

17. An open sided grip as recited in claim 14, further comprising a longitudinal opening positioned across the central cavity of the grip body from the protrusion.

18. An open sided grip as recited in claim 14, wherein the grip body comprises a hard plastic material, and the elastic portion comprises an elastomer.

19. An open sided grip as recited in claim 14, wherein pressure exerted on the grip body causes compression of the elastic portion.

20. An open sided grip as recited in claim 14, wherein the outer surface of the elastic portion is raised in relation to an external surface of the grip body.
